(19) United States
(12) Patent Application Publication
(10) Pub. No.: US 2026/0319755 A1
(43) Pub. Date: Oct. 15, 2026

(54) DEVICES, SYSTEMS, AND METHODS FOR CONTINUOUSLY ENHANCING THE IMPLEMENTATION OF CODE CHANGES VIA ENRICHED PIPELINES

(71) Applicant: BlueVoyant LLC, New York, NY (US)

(72) Inventor: Marcin Tustin, New York, NY (US)

(73) Assignee: BlueVoyant LLC, New York, NY (US)

(21) Appl. No.: 19/111,118

(22) PCT Filed: Sep. 18, 2023
(86) PCT No.: PCT/US2023/074468

§ 371 Date: Mar. 12, 2025

Related U.S. Application Data
(60) Provisional application No. 63/377,304, filed on Sep. 27, 2022.

(51) Int. Cl. G06F 8/30

(52) U.S. Cl. CPC G06F 8/30

(57) ABSTRACT

A continuous integration server configured to enhance an implementation of code changes is disclosed herein. The continuous integration server can include a processor and a memory configured to store a continuous integration platform that, when executed by the processor, causes the continuous integration server to access a plurality of project-specific files hosted on a repository server, determine that a subset of the plurality of project-specific files has changed, generate a specific task exclusively associated with the changed subset of the plurality of project-specific files, and transmit the specific task to a software development server configured to execute the specific task, wherein execution of the specific task exclusively effects the changed subset of the plurality of project-specific files.

### CROSS-REFERENCE TO RELATED APPLICATIONS

The present application is related to U.S. Provisional Patent Application No. 63/377,304, titled DEVICES, SYSTEMS, AND METHODS FOR CONTINUOUSLY ENHANCING THE IMPLEMENTATION OF CODE CHANGES VIA ENRICHED PIPELINES, filed Sep. 27, 2022, the disclosure of which is incorporated by reference in its entirety herein.

### FIELD

The present disclosure is generally related to network security, and, more particularly, is directed to improved devices, systems, and methods for continuously implementing changes to code via pipelines enriched with specific information pertaining to the code changes.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a method of enhancing an implementation of code changes is disclosed. The method can include accessing, via a continuous integration platform, a plurality of project-specific files hosted on a repository server, wherein the repository server is configured as a monolithic repository configured to host the plurality of project-specific files, determining, via the continuous integration platform, that a subset of the plurality of project-specific files has changed, generating, via the continuous integration platform, a specific task exclusively associated with the changed subset of the plurality of project-specific files, and transmitting, via the continuous integration platform, the specific task to a software development server configured to execute the specific task, wherein execution of the specific task exclusively effects the changed subset of the plurality of project-specific files.

In various aspects, a system configured to enhance an implementation of code changes is disclosed. The system can include a software development server, a repository server configured to host a plurality of project-specific files, and a continuous integration server including a processor and a memory configured to store a continuous integration platform that, when executed by the processor, causes the continuous integration server to access the plurality of project-specific files hosted on the repository server, determine that a subset of the plurality of project-specific files has changed, generate a specific task exclusively associated with the changed subset of the plurality of project-specific files, and transmit the specific task to the software development server, wherein the software developer server is configured to execute the specific task, and wherein execution of the specific task exclusively effects the changed subset of the plurality of project-specific files.

In various aspects, a continuous integration server configured to enhance an implementation of code changes is disclosed. The continuous integration server can include a processor, and a memory configured to store a continuous integration platform that, when executed by the processor, causes the continuous integration server to access a plurality of project-specific files hosted on a repository server, determine that a subset of the plurality of project-specific files has changed, generate a specific task exclusively associated with the changed subset of the plurality of project-specific files, and transmit the specific task to a software development server configured to execute the specific task, wherein execution of the specific task exclusively effects the changed subset of the plurality of project-specific files.

These, and other objects, features, and characteristics of the present invention, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the invention.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

FIG. 1 illustrates a block diagram of a system configured to enhance the implementation of code changes via enriched pipelines, in accordance with at least one non-limiting aspect of the present disclosure;

FIG. 2 illustrates a block diagram of several tasks generated by the system of FIG. 1, in accordance with at least one non-limiting aspect of the present disclosure;

FIG. 3 illustrates a pipeline generated by the system of FIG. 1, in accordance with at least one non-limiting aspect of the present disclosure;

FIG. 4 illustrates a method of enhancing the implementation of code changes via enriched pipelines, in accordance with at least one non-limiting aspect of the present disclosure; and

FIG. 5 illustrates a security information and event management system (“SIEM”) configured to benefit from the system of FIG. 1 and method of FIG. 4, in accordance with at least one non-limiting aspect of the present disclosure.

Corresponding reference characters indicate corresponding parts throughout the several views. The exemplifications set out herein illustrate various aspects of the invention, in one form, and such exemplifications are not to be construed as limiting the scope of the invention in any manner.

The Applicant of the present application owns the following U.S. Provisional Patent Applications, the disclosure of each of which is herein incorporated by reference in its entirety:
U.S. Provisional Patent Application No. 63/294,570 titled DEVICES, SYSTEMS, AND METHODS FOR PROVISIONING AND UPDATING SECURITY INFORMATION & EVENT MANAGEMENT ARTIFACTS FOR MULTIPLE TENANTS, filed on Dec. 29, 2021;
U.S. Provisional Patent Application No. 63/295,150 titled DEVICES, SYSTEMS, AND METHODS FOR STREAMLINING AND STANDARDIZING THE INGEST OF SECURITY DATA ACROSS MULTIPLE TENANTS, filed on Dec. 30, 2021;
U.S. Provisional Patent Application No. 63/302,828 titled DEVICES, SYSTEMS, AND METHODS FOR REMOTELY MANAGING ANOTHER ORGANIZATION'S SECURITY ORCHESTRATION, AUTOMATION, AND RESPONSE, filed on Jan. 25, 2022;
U.S. Provisional Patent Application No. 63/313,422 titled DEVICES, SYSTEMS, AND METHODS FOR IDENTIFYING CYBER ASSETS AND GENERATING CYBER RISK MITIGATION ACTION BASED ON DOMAIN REDIRECTS, filed on Feb. 24, 2022;
U.S. Provisional Patent Application No. 63/341,264 titled DEVICES, SYSTEMS, AND METHODS FOR SUMMARIZING ANALYTIC OBSERVATIONS, filed on May 12, 2022;
U.S. Provisional Patent Application No. 63/344,305 titled DEVICES, SYSTEMS, AND METHODS FOR INGESTING & ENRICHING SECURITY INFORMATION TO AUTONOMOUSLY SECURE A PLURALITY OF TENANT NETWORKS, filed on May 20, 202;
U.S. Provisional Patent Application No. 63/345,679 titled DEVICES, SYSTEMS, AND METHODS FOR IDENTIFYING CYBER ASSETS AND GENERATING CYBER RISK MITIGATION ACTIONS BASED ON A DEMOCRATIC MATCHING ALGORITHM, filed on May 25, 2022
International Patent Application No. PCT/US22/72739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022;
International Patent Application No. PCT/US22/72743, titled DEVICES, SYSTEMS, AND METHODS FOR STANDARDIZING & STREAMLINING THE DEPLOYMENT OF SECURITY INFORMATION & EVENT MANAGEMENT ARTIFACTS FOR MULTIPLE TENANTS, filed on Jun. 3, 2022;
U.S. Provisional Patent Application No. 63/365,819 titled DEVICES, METHODS, AND SYSTEMS FOR GENERATING A HIGHLY-SCALABLE, EFFICIENT COMPOSITE RECORD INDEX, filed on Jun. 3, 2022
U.S. Provisional Patent Application No. 63/353,992 titled DEVICES, SYSTEMS, AND METHODS FOR CATEGORIZING, PRIORITIZING, AND MITIGATING CYBER SECURITY RISKS, filed on Jun. 21, 2022;
U.S. Provisional Patent Application No. 63/366,903 titled DEVICES, SYSTEMS, AND METHOD FOR GENERATING AND USING A QUERYABLE INDEX IN A CYBER DATA MODEL TO ENHANCE NETWORK SECURITY, filed on Jun. 23, 2022;
U.S. Provisional Patent Application No. 63/368,567 titled DEVICES, SYSTEMS, AND METHODS FOR UTILIZING A NETWORKED, COMPUTER-ASSISTED, THREAT HUNTING PLATFORM TO ENHANCE NETWORK SECURITY, filed on Jul. 15, 2022; and
U.S. Provisional Patent Application No. 63/369,582 titled AUTONOMOUS THREAT SCORING AND SECURITY ENHANCEMENT, filed on Jul. 27, 2022.

Numerous specific details are set forth to provide a thorough understanding of the overall structure, function, manufacture, and use of the aspects as described in the disclosure, and illustrated in the accompanying drawings. Well-known operations, components, and elements have not been described in detail so as not to obscure the aspects described in the specification. The reader will understand that the aspects described, and illustrated herein are non-limiting aspects, and thus it can be appreciated that the specific structural, and functional details disclosed herein may be representative, and illustrative.

Before explaining various aspects of the systems, and methods disclosed herein in detail, it should be noted that the illustrative aspects are not limited in application or use to the details disclosed in the accompanying drawings, and description. It shall be appreciated that the illustrative aspects may be implemented or incorporated in other aspects, variations, and modifications, and may be practiced or carried out in various ways. Further, unless otherwise indicated, the terms, and expressions employed herein have been chosen for the purpose of describing the illustrative aspects for the convenience of the reader, and are not for the purpose of limitation thereof. For example, it shall be appreciated that any reference to a specific manufacturer, software suite, application, or development platform disclosed herein is merely intended to illustrate several of the many aspects of the present disclosure. This includes any, and all references to trademarks. Accordingly, it shall be appreciated that the devices, systems, and methods disclosed herein can be implemented to enhance any software update, in accordance with any intended use, and/or user preference.

As used herein, the term “server” may refer to or include one or more computing devices that are operated by or facilitate communication, and processing for multiple parties in a network environment, such as the Internet or any public or private network. Reference to “a server” or “a processor,” as used herein, may refer to a previously-recited server, and/or processor that is recited as performing a previous step or function, a different server, and/or processor, and/or a combination of servers, and/or processors.

As used herein, the term “network” can include an entire enterprise information technology (“IT”) system, as deployed by a tenant. For example, a network can include a group of two or more nodes (e.g., assets) connected by any physical and/or wireless connection and configured to communicate and share information with the other node or nodes. However, the term network shall not be limited to any particular nodes or any particular means of connecting those nodes. A network can include any combination of assets (e.g., devices, servers, desktop computers, laptop computers, personal digital assistants, mobile phones, wearables, smart appliances, etc.) configured to connect to an ethernet, intranet, and/or extranet and communicate with one another via an ad hoc connection (e.g., Bluetooth®, near field communication (“NFC”), etc.), a local area connection (“LAN”), a wireless local area network (“WLAN”), and/or a virtual private network (“VPN”), regardless of each devices' physical location. A network can further include any tools, applications, and/or services deployed by devices, or otherwise utilized by an enterprise IT system, such as a firewall, an email client, document management systems, office systems, etc. In some non-limiting aspects, a “network” can include third-party devices, applications, and/or services that, although they are owned and controlled by a third party, are authorized by the tenant to access the enterprise IT system.

As used herein, the term “platform” can include software architectures, hardware architectures, and/or combinations thereof. A platform can include either a stand-alone software product, a network architecture, and/or a software product configured to integrate within a software architecture and/or a hardware architecture, as required for the software product to provide its technological benefit. For example, a platform can include any combination of a chipset, a processor, a logic-based device, a memory, a storage, a graphical user interface, a graphics subsystem, an application, and/or a communication module (e.g., a transceiver). In other words, a platform can provide the resources required to enable the technological benefits provided by software. According to some non-limiting aspects, the technological benefit provided by the software is provided to the physical resources of the ecosystem or other software employed by physical resources within the ecosystem (e.g., APIs, services, etc.). According to other non-limiting aspects, a platform can include a framework of several software applications intended and designed to work together.

As used herein, the term “repository” can include any version control system and/or source control system, including any system and/or platform configured to track and/or manage changes to software code. For example, a repository can include Git, Subversion, Concurrent Versions System (“CVS”), Microsoft Azure, Darcs, and/or Mercurial, amongst others.

Continuous integration is a software development practice in which all developers merge code in a single repository multiple times a day. There are two primary types of known repository structures by which developers can implement continuous integration. A monolithic repository or “monorepo,” as used herein, can include a single version-controlled code repository configured to contain code associated with many projects. For example, many large companies such as Google, Microsoft, Facebook, and Twitter choose to host all of their code in a single, monolithic repository, shared amongst the entire development team. As such, monorepos can reach colossal sizes, exceeding tens to hundreds of terabytes, and must be configured to support hundreds of commits per day. Although certain projects may be related, they can be logically independent and run by different teams. Thus, many developers choose to alternately organize code by drawing project-specific boundaries into multiple repositories or “multirepos,” as used herein. Developers can, therefore, make case-by-case determinations as to which code should be stored in which of the project-specific multirepos. Multirepos, however, are inherently stove-piped. Whereas monorepos can enable the establishment of relationships and/or certain degrees of interoperability between projects, multirepos cannot lack the integration of monorepos. In other words, monorepos enable a comprehensive and integrated storage of code that is not feasible via multirepos. An additional benefit of monorepo-based software management is the ability to track which versions of software can be deployed together.

However, although monorepos make it easier to manage relationships between different project-specific codes, it can be more difficult to execute tasks across the large volume of content in a monorepo. For example, conventional monorepo tools generally deploy a single, comprehensive and otherwise unaltered pipeline configured to execute all tasks regardless of how small or limited the scope of a code change. This can lead to an inefficient use of computing resources and/or developer time, as the monorepo executes tests across all of the code regardless of how small a particular change can be. In other words, although monorepos can be beneficial for the large scale development of software, it is less ideal for the efficient implementation of code changes for smaller projects. Accordingly, there is a need for devices, systems, and method for continuously enhancing the implementation of code changes via enriched pipelines. Such devices, systems, and methods can enable developers to streamline software development developer experience, so developers do not need to wait for a change to be built, deployed, or tested in unnecessary ways.

Moreover, devices, systems, and method for continuously enhancing the implementation of code changes via enriched pipelines can be practically integrated into software development tools and architectures that produce numerous technological improvements over conventional tools deployed to interface with monorepos. For example, such devices, systems, and methods can automate software delivery, assembly code, run tests, and safely deploy new versions of an application autonomously, based on a detected subset of changed selected files, instead of wasting computational resources and time addressing every file—changed and unchanged—in the monorepo. This can enable a development team to accomplish more with less human resources, computational resources, and time. Additionally, since the systems, and methods disclosed herein can autonomously detect specific changes, without human input, continuous integration can be truly continuous, ensuring that specific project builds are monitored and deployed regardless of the date or time changes are enacted by the development team.

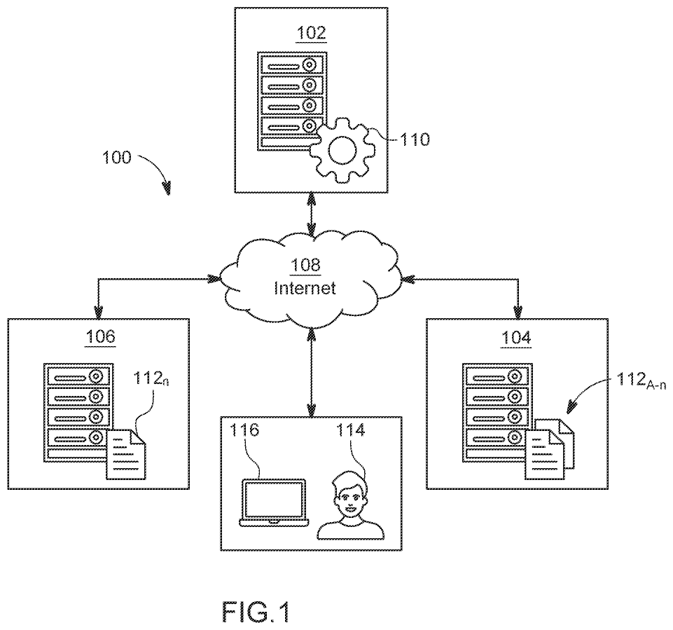

Referring now to FIG. 1, a block diagram of a system 100 configured to enhance the implementation of code changes via enriched pipelines is depicted in accordance with at least one non-limiting aspect of the present disclosure. According to the non-limiting aspect of FIG. 1, the system 100 can include a continuous integration server 102, a repository server 104, and a software development server 106 communicably coupled via a network, such as the internet 108 or any other means of networked communication (e.g., cellular network, intranet, etc.). Of course, according to other non-limiting aspects, the continuous integration server 102, the repository server 104, and the software development server 106 can be one of a plurality of servers specifically implemented for the particular functions that will be described herein with reference to each. For example, the repository server 104 may be one of a plurality of repository servers configured to perform the functions disclosed herein with reference to the repository server 104 of FIG. 1. It shall be further appreciated that each of the continuous integration server 102, a repository server 104, and a software development server 106 can include a memory communicably coupled to a processor.

For example, according to the non-limiting aspect of FIG. 1, the continuous integration server 102 can include a memory configured to store a continuous integration platform 110 that, when executed by a processor of the continuous integration server 102, causes the continuous integration server 102 to interact with the repository server 104 and the software development server 106 in accordance with the functions and methods disclosed herein. The continuous integration platform 110 can cause the continuous integration server 102 to act as a third party interface between the repository server 104 and the software development server 106. Specifically, the continuous integration platform 110 can be particularly configured to generate one or more pipelines comprising one or more specific tasks (e.g., code testing, code merges, etc.) to enhance the implementation of code changes, as will be described in further detail herein.

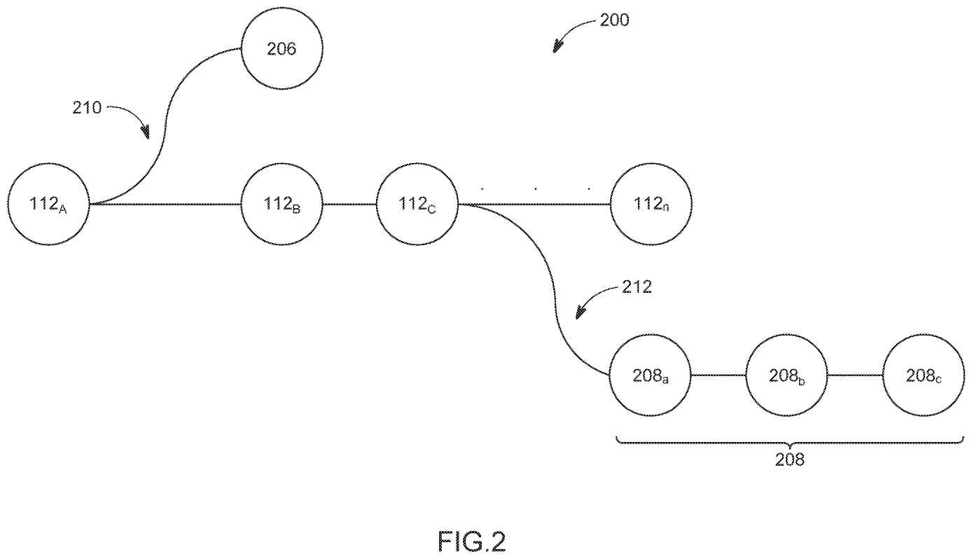

According to the non-limiting aspect of FIG. 1, the repository server 104 can be configured to store a plurality of files 112_{A-n}, such as various project-specific software codes, and can be further configured to host and execute a content repository platform (e.g., Git, Subversion, CVS, Microsoft Azure, Darcs, Mercurial, etc.). For example, via the content repository platform, the repository server 104 can be configured to track and/or manage changes to the plurality of files 112_{A-n} implemented by one or more developers 114 via a computing device 116 (e.g., a personal computer, a laptop computer, a tablet, a smartphone, etc.), as will be described in further detail with reference to FIG. 2. In other words, the repository server 104 can include a version control system and/or a source control system such as a monorepo, or single version-controlled code repository configured to contain code associated with many projects. Thus, the plurality of files 112_{A-n} can be exceedingly large.

Moreover, the repository server 104 can be configured to support hundreds of commits per day, as each of the plurality of files 112_{A-n} can be logically independent and run by different teams.

In further reference to FIG. 1, the software development server 106 can be configured to host and execute a software development platform (e.g., Gitlab, Github, Azure DevOps and Pipelines, Bitbucket, Jenkins, etc.) configured to facilitate the collaborative software development platform for large software development projects, such as DevOps. The software development server 106, via the software development platform, can be used to enable developers 114 to collaboratively plan, build, secure, and deploy software as a complete platform across the entire development cycle. Specifically, the software development server 106 can be configured to execute pipelines and/or tasks generated by the continuous integration platform 110, in association with one or more of the plurality of files 112_{A-n}.

Still referring to FIG. 1, the continuous integration server 102, via the continuous integration platform 110, can be particularly configured to accessing the plurality of project-specific files 112_{A-n} hosted on the repository server 104. According to some non-limiting aspects, the continuous integration platform 110 can be configured to access and review the plurality of project-specific files 112_{A-n} hosted on the repository server 104 periodically, in accordance with a predetermined time interval (e.g., every five seconds, every minute, every hour, every day, etc.). The continuous integration server 102, via the continuous integration platform 110, can further be configured to determine that a subset 112ₙ of the plurality of project-specific files 112_{A-n} has changed. This detection can be autonomous and can occur multiple times a day, according to a predetermined period. For example, the subset 112ₙ can include at least one of the plurality of project-specific files 112_{A-n} that the continuous integration platform 110 has determined to have been updated or otherwise modified by one or more developers 114 since the last time the plurality of project-specific files 112_{A-n} was accessed and reviewed. Upon determining that a subset 112ₙ of the plurality of project-specific files 112_{A-n} has changed, the continuous integration server 102, via the continuous integration platform 110, can autonomously execute one or more tasks (e.g., build, merge, test, scan, etc.).

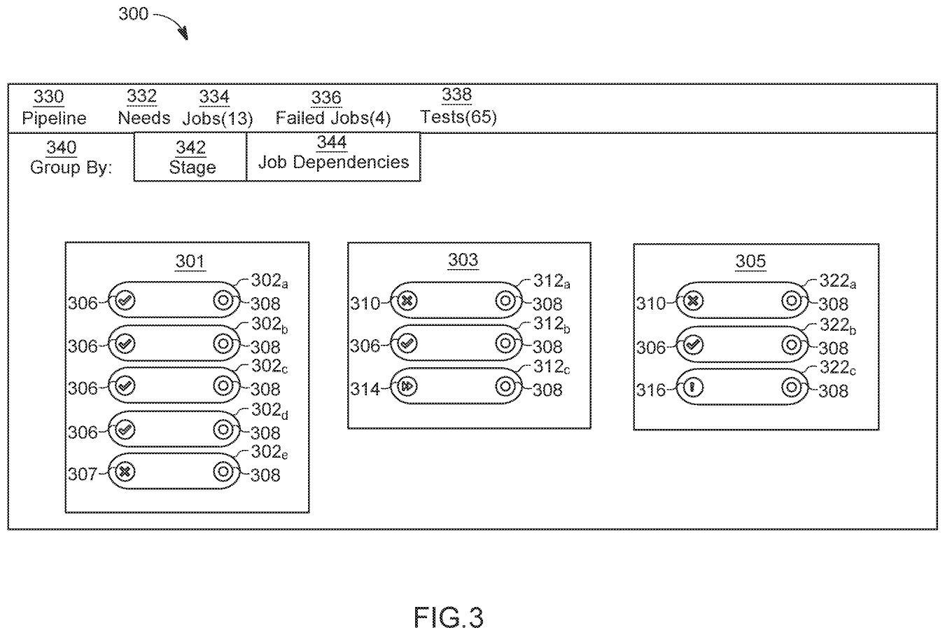

However, the continuous integration platform 110 of the continuous integration server 102 of the system 100 of FIG. 1 can be further configured to generate customized task 210, 212 (FIG. 2) or a pipeline 301, 303, 305 (FIG. 3) of tasks exclusively associated with the changed subset 112ₙ of the plurality of project-specific files 112_{A-n}. The continuous integration server 102 can be configured to transmit the task 210, 212 (FIG. 2) or pipeline 301, 303, 305 (FIG. 3), associated with the changed subset 112ₙ to the software development server 106 for execution. However, upon execution of the specific task, the software development server 106 need only take action on the changed subset of the plurality of project-specific files 112_{A-n}, instead of the entire plurality.

As such, developers 114 of FIG. 1 can benefit from multirepo-like agility and efficiencies, across a large plurality of project-specific files 112_{A-n} stored by the repository server 104, or monorepo. For example, benchmark testing indicates significant technological benefits associated with the execution of specific tasks and pipelines generated by the continuous integration platform 110 of the continuous integration server 102. According to one test, tasks, such as code merges, generated by the continuous integration platform 110 and executed by the software development server 106 took several minutes and—in some instances—mere seconds to complete, compared to twenty minutes to complete comparable sized tasks generated and performed by conventional systems. Of course, the system 100 of FIG. 1 lacks the stovepiping of multirepo systems and retains the relationship tracking and interoperability provided by conventional multirepos configured to store a comparably sized plurality of files 112_{A-n}. Thus, the technological improvements provided by the system 100 of FIG. 1 are evident and significant.

Referring now to FIG. 2, a block diagram of several tasks 210, 212 generated by the system 100 of FIG. 1 is depicted in accordance with at least one non-limiting aspect of the present disclosure. For example, the tasks 210, 212 generated by the system 100 of FIG. 1 can include any number of software-related tasks, including merging of changes 206, 208_{a-c}, testing of project-specific files 112_{A-n}, , and/or security-related tasks, amongst others. According to the non-limiting aspect of FIG. 2, the plurality of project-specific files 112_{A-n} are depicted as stored by the repository server 104 of FIG. 1. However, as depicted in FIG. 2, a first code change 206 has been implemented in a first project-specific file 112_{A} of the plurality of project-specific files 112_{A-n} and a second code change 208 has been implemented against a second project-specific file 112_{c} of the plurality of project-specific files 112_{A-n}. Accordingly, the system 100 of FIG. 1 has generated a first task 210 associated with the first code change 206 implemented in the first project-specific file 112_{A} and a second task 212 associated with the second code change 208 implemented in the second project-specific file 112_{c}.

As such, it shall be appreciated that the first task 210 and the second task 212, as depicted in FIG. 2 and generated by the system 100 of FIG. 1, can be utilized to enhance the implementation of code changes. Specifically, the first change 206 includes a single piece of affected code 206 and thus, far less code will actually be affected by the first code change 206. Contrarily, the second code change 208 comprises numerous pieces 208_{a-c} of affected code and thus, much more code will be affected by the second code change 208. Accordingly, FIG. 2 depicts the benefit of a system 100 (FIG. 1) configured to generate a first task 210 and a second task 212 that can be discretely executed by a software development server 106. If a developer 114 (FIG. 1) is only working on the first project-specific file 112_{A} of the plurality of project-specific files 112_{A-n}, it would be unnecessary and thus, inefficient to implement the second task 212 because it is exclusively associated with the second project-specific file 112_{c}. This is especially true since the scope of changes 208_{a-c} associated with the second project-specific file 112_{c} is significantly larger than the single change 206 associated with the first project-specific file 112_{A}—the only project-specific file 112_{A} the developer 114 (FIG. 1) is interested in at the moment. In other words, the system 100 of FIG. 1 is able to intelligently detect and manage changes implemented in the plurality of project-specific files 112_{A-n} and generate discrete tasks 210, 212 that can be independently executed by the software development server 106. Accordingly, the tasks 210, 212 of FIG. 2 can enable a developer 114 (FIG. 1) to exclusively focus on a task-at-hand 210 without having to commit computing resources to unnecessary tasks 212 implemented within project-specific file 112_{c} that may be momentarily irrelevant to their work on a desired project-specific file 112_{A}.

Referring now to FIG. 3, a user interface 300 displaying several pipelines 301, 303, 305 generated by the system 100 of FIG. 1 is depicted in accordance with at least one non-limiting aspect of the present disclosure. For example, according to some non-limiting aspects, the user interface 300 of FIG. 3 can be generated by the continuous integration platform 110 (FIG. 1) of the continuous integration server 102 (FIG. 1) and accessed via the computing device 116 114 (FIG. 1) of one or more developers 114 (FIG. 1). According to the non-limiting aspect of FIG. 3, the user interface 300 can display one of several pipelines 301, 303, 305, including a build pipeline 301, a test pipeline 303, and a security pipeline 305 (e.g., static application security (“SAST”) scan), amongst others.

In further reference to the non-limiting aspect of FIG. 3, each of the generated pipelines 301, 303, 305 can include one or more related tasks 302ₐ₋ₑ, 312_{a-c}, 322_{a-c} associated with one or more of the project-specific files 112_{A-n} (FIG. 1) stored on the repository server 104 (FIG. 1). For example, the build pipeline 301 can include tasks such as build: cloudfunctions 302ₐ, build:peeprBackend 302_{b}, build:pubapi 302_{c}, build:pubapi-tokens 302_{d}, and/or build:riskapi 302ₑ, amongst others. The test pipeline 303 can include tasks such as test:peeprBackend 312ₐ, test:swagger 312_{b}, and/or test:vet-peeprBackend 302_{c}, amongst others and the scan pipeline 305 can include tasks such as gosec:peeprBackend 322ₐ, shiftleft:pubapi 322_{b}, and/or shiftleft:riskapi 322_{c}, amongst others. In other words, each task 302ₐ₋ₑ, 312_{a-c}, 322_{a-c} of each of the pipelines 301, 303, 305 displayed by the user interface 300 of FIG. 3 can specify a task to be performed on a particular project-specific file 112_{A-n} of the plurality of project-specific files 112_{A-n}. Of course, the pipelines 301, 303, 305 and tasks 302ₐ₋ₑ, 312_{a-c}, 322_{a-c} depicted in FIG. 3 are merely illustrative and, according to other non-limiting aspects, the present disclosure contemplates a number of different types of pipelines and tasks generated by the system 100 of FIG. 1.

Still referring to FIG. 3, each task 302ₐ₋ₑ, 312_{a-c}, 322_{a-c} of each pipeline 301, 303, 305 can further include one or more action buttons 308 and/or one or more status buttons 306, 307, 310, 314, 316. For example, if a developer 114 (FIG. 1) engages an action buttons 308, the continuous integration platform 110 can cause the continuous integration server 102 to perform a particular task 302ₐ₋ₑ, 312_{a-c}, 322_{a-c} again. Likewise, each status button 306, 307, 310, 314, 316 can provide the developer 114 (FIG. 1) with an indication as to the last time a particular task 302ₐ₋ₑ, 312_{a-c}, 322_{a-c} was executed by the continuous integration server 102. For example, a first status button 306 can indicate that the last execution of a particular task 302ₐ₋ₑ, 312_{a-c}, 322_{a-c} was successful. A second status button 307 can be configured as a failure indicator that indicates that the last execution of a particular task 302ₐ₋ₑ, 312_{a-c}, 322_{a-c} was not successful. A third status button 314 can indicate that the last execution of a particular task 302ₐ₋ₑ, 312_{a-c}, 322_{a-c} is in process or pending. A fourth status button 316 can be configured as an alert indicator that indicates that the last execution of a particular task warrants attention. According to some non-limiting aspects, a user interaction (e.g., clicking the fourth status buttons 316, etc.) can provide the developer 114 (FIG. 1) with more information regarding the last execution of the particular task a first status button 306 can indicate that the last execution of a particular task 302ₐ₋ₑ, 312_{a-c}, 322_{a-c}.

The user interface 300 of FIG. 3 can further enable a developer 114 (FIG. 1) to review generated tasks 302ₐ₋ₑ, 312_{a-c}, 322_{a-c} and/or pipelines 301, 303, 305 in different aggregations. For example, according to the non-limiting aspect of FIG. 3, a pipeline view 330 is depicted. However, the developer 114 (FIG. 1) can further review generated tasks 302ₐ₋ₑ, 312_{a-c}, 322_{a-c} and/or pipelines 301, 303, 305 according to a project-specific needs view 332, a jobs view 334, a failed jobs view 336, and/or a tests view 338. In other words, the various tasks 302ₐ₋ₑ, 312_{a-c}, 322_{a-c} generated by the continuous integration platform 110 (FIG. 1) of the continuous integration server 102 (FIG. 1) can be further aggregated by task 302ₐ₋ₑ, 312_{a-c}, 322_{a-c} type, task 302ₐ₋ₑ, 312_{a-c}, 322_{a-c} status, and/or project needs, for example. Moreover, when in pipeline view 330, the developer 114 (FIG. 1) can further toggle a “group by” widget 340, to view generated tasks 302ₐ₋ₑ, 312_{a-c}, 322_{a-c} and/or pipelines 301, 303, 305 via a stage view 342, as depicted in FIG. 3, or a job dependency view 344, amongst other groupings contemplated by the present disclosure but not depicted in FIG. 3.

Each pipeline 301, 303, 305 can be configured for automatically execution upon the continuous integration server 102 (FIG. 1), via the continuous integration platform 110 (FIG. 1), detecting that a subset of project-specific files 112_{N} (FIG. 1) has changed. Thus, the change in code can trigger a notification to the continuous integration server 102 (FIG. 1) and/or the continuous integration platform 110 (FIG. 1), which subsequently executes a corresponding pipeline 301, 303, 305. However, according to other non-limiting aspects, pipeline 301, 303, 305 execution can be scheduled and/or triggered based on the results of other executed pipelines 301, 303, 305. Thus, the continuous integration platform 110 (FIG. 1), via the pipelines 301, 303, 305, can be implemented to efficiently automate a software delivery process on a monorepo-type repository server 104 (FIG. 1). For example, the pipelines 301, 303, 305 can be used to build code, runs tests, and safely deploy a new version of an application associated only with the subset of project-specific files 112_{N}. The pipelines 301, 303, 305 can be configured to remove manual errors, provide standardized feedback loops to developers 114 (FIG. 1), and enable faster product iterations. According to some non-limiting aspects, the enriched pipelines 301, 303, 305 accelerated the entire continuous integration feedback loop to mere seconds, without compromising the quality of developer 114 (FIG. 1) feedback or results.

In summary, the user interface 300 of FIG. 3 illustrates how the continuous integration platform 110 (FIG. 1) of the continuous integration server 102 (FIG. 1) can be used to not only generate specific tasks 302ₐ₋ₑ, 312_{a-c}, 322_{a-c} associated with a subset of project-specific files 112_{A-n} stored on the repository server 104, but can also aggregate the generated tasks 302ₐ₋ₑ, 312_{a-c}, 322_{a-c} into specific and enriched continuous integration pipelines 301, 303, 305, which can be implemented with specificity to further streamline integration and further reduce computational resource usage and enhance efficiencies.

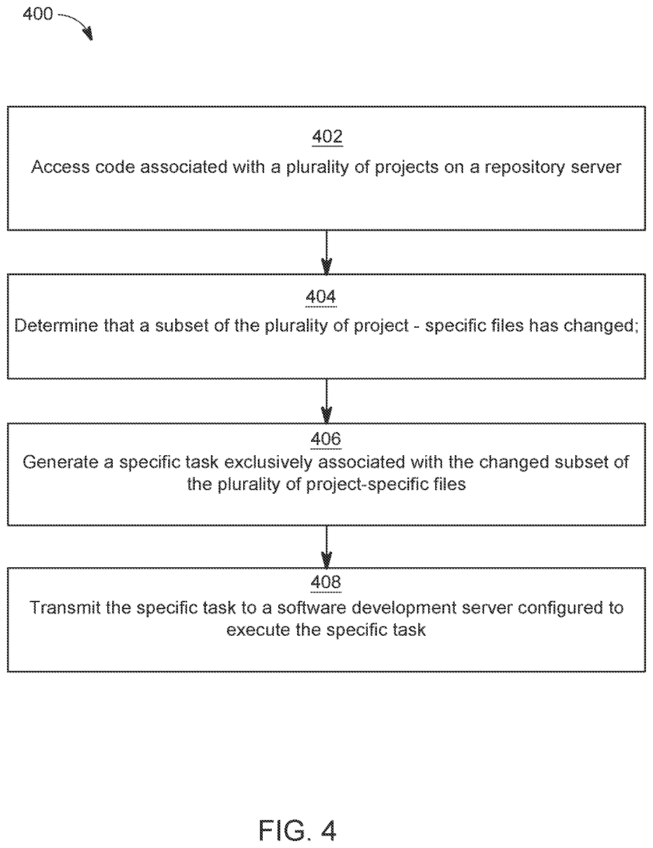

Referring now to FIG. 4, a method 400 of enhancing the implementation of code changes via enriched pipelines is depicted in accordance with at least one non-limiting aspect of the present disclosure. It shall be appreciated that the method 400 of FIG. 4 can be implemented via a continuous integration server 102 (FIG. 1)—and more specifically, via a continuous integration platform 110 (FIG. 1) hosted on a continuous integration server 102 (FIG. 2). However, according to other non-limiting aspects, the method 400 can be implemented via any other component of the system 100 of FIG. 1 to achieve a similar result. According to non-limiting aspect of FIG. 4, the method can include accessing 402 a plurality of project-specific files 112_{A-n} (FIG. 1) hosted on the repository server 104 (FIG. 1). For example, the accessing 402 can occur autonomously and/or periodically, in accordance with a predetermined time interval (e.g., every five seconds, every minute, every hour, every day, etc.).

In further reference to FIG. 4, the method 400 can further include detecting 404 that a subset 112ₙ (FIG. 1) of the plurality of project-specific files 112_{A-n} (FIG. 1) has changed. According to some non-limiting aspects, the detecting 404 can be autonomous. However, according to other non-limiting aspects, the detecting 404 can occur in response to a user-provided input regarding which subset 112ₙ (FIG. 1) of the plurality of project-specific files 112_{A-n} (FIG. 1) has changed. For example, the subset 112ₙ (FIG. 1) can include at least one of the plurality of project-specific files 112_{A-n} (FIG. 1) that the continuous integration platform 110 has determined to have been updated or otherwise modified by one or more developers 114 since the last time the plurality of project-specific files 112_{A-n} was accessed and reviewed.

Upon determining that a subset 112ₙ of the plurality of project-specific files 112_{A-n} has changed, the method 400 of FIG. 4 can further include generating 406, a specific task 210, 212 (FIG. 2) or a pipeline 301, 303, 305 (FIG. 3) of specific tasks exclusively associated with the changed subset 112ₙ (FIG. 1) of the plurality of project-specific files 112_{A-n} (FIG. 1). According to the non-limiting aspect of FIG. 4, the method 400 can further include transmitting 408, the generated task 210, 212 (FIG. 2) or pipeline 301, 303, 305 (FIG. 3) associated with the changed subset 112ₙ (FIG. 1) to the software development server 106 (FIG. 1) for execution. As such, upon execution of the specific task, the software development server 106 (FIG. 1) need only take action on the changed subset 112_{N} of the plurality of project-specific files 112_{A-n} (FIG. 1), instead of the entire plurality of project-specific files 112_{A-n} (FIG. 1). As such, the method 400 of FIG. 4 can enable multirepo-like agility and efficiencies, across a large plurality of project-specific files 112_{A-n} (FIG. 1) stored by the repository server 104 (FIG. 1) that, according to some non-limiting aspects, can be configured as a monorepo.

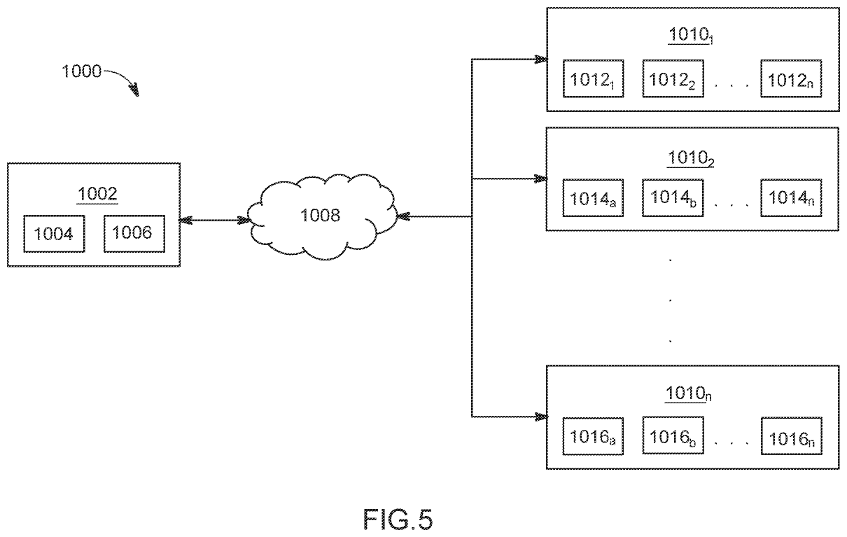

Referring now to FIG. 5, block diagram of a security information and event management system (“SIEM”) 1000 configured to benefit from the system 100 of FIG. 1 and method 400 of FIG. 4 is depicted in accordance with at least one non-limiting aspect of the present disclosure. For example, according to some non-limiting aspect, the SIEM system 100 of FIG. 5 can be configured similar to those described in International Patent Application No. PCT/US22/72739, titled DEVICES, SYSTEMS, AND METHODS FOR ENHANCING SECURITY INFORMATION & EVENT MANAGEMENT UPDATES FOR MULTIPLE TENANTS BASED ON CORRELATED, AND SYNERGISTIC DEPLOYMENT NEEDS, filed on Jun. 3, 2022, the disclosure of which is hereby incorporated by reference in its entirety. According to the non-limiting aspect of FIG. 5, the system 1000 can include a MSSP provider server 1002 comprising a memory 1006 configured to store a SOAR application, such as the SOAR application described in U.S. Provisional Patent Application No. 63/302,828 titled DEVICES, SYSTEMS, AND METHODS FOR REMOTELY MANAGING ANOTHER ORGANIZATION'S SECURITY ORCHESTRATION, AUTOMATION, AND RESPONSE, filed on Jan. 25, 2022, the disclosure of which is hereby incorporated by reference in its entirety.

The system 1000 can further include a processor 1004. For example, the MSSP provider server 1002 can be a computational resource either owned or leased by the managed security service provider (“MSSP”). The MSSP provider server 1002 can be communicably coupled, via network 1008, to a plurality of tenants 1010₁, 1010₂ . . . 1010n. Each tenant 1010₁, 1010₂ . . . 1010ₙ of the plurality can represent a customer (e.g., organization) contracting with the MSSP. According to the non-limiting aspect of FIG. 5, the network 1008 can include any variety of wired, long-range wireless, and/or short-range wireless networks. For example, the network 1008 can include an internal network, a Local Area Networks (LAN), WiFi®, cellular networks, near-field communication (hereinafter “NFC”), amongst others. The MSSP provider server 1002 can be configured to perform SIEM services and, more specifically, SOAR management services on behalf of a plurality of tenants 1010₁, 1010₂ . . . 1010ₙ.

In further reference to FIG. 5, each tenant 1010₁, 1010₂ . . . 1010ₙ of the plurality can host one or more instances of one or more clients 1012, 1014, 1016. For example, a first tenant 1010₁ can include one or more machines implementing one or more client applications 1012₁, 1012₂ . . . 1012ₙ, a second tenant 1010₂ can include one or more machines implementing one or more client applications 1014₁, 1014₂ . . . 1014ₙ, and/or a third tenant 1010ₙ can include one or more machines implementing one or more client applications 1016₁, 1016₂ . . . 1016ₙ. Each tenant 1010₁, 1010₂, and 1010ₙ can include an intranet by which each machine implementing the client applications. For example, each tenant 1010₁, 1010₂, and 1010ₙ can each represent a customer, such as an organization, contracting with the MSSP for security services.

Accordingly, the MSSP provider server 1002 can be configured to have oversight of each tenant 1010₁, 1010₂, and 1010ₙ of the plurality, and thus, is responsible for monitoring, and managing each client application 1012, 1014, 1016 for threats. As previously discussed, the differences, and complexity in tenant 1010₁, 1010₂, and 1010ₙ architecture can complicate this, and render it inefficient for the MSSP. Thus, known SOAR tools can leave the tenants 1010₁, 1010₂, and 1010ₙ technologically exposed, and thus, vulnerable to attacks. According to non-limiting aspects of the present disclosure, the MSSP provider server 1002 can implement a SOAR management application that technologically, and practically addresses these deficiencies by enhancing the ability of the MSSP provider server 1002 to manage, and transmit alerts, and client application updates for multiple tenants based on correlated, and synergistic development needs.

Various aspects of the subject matter described herein are set out in the following numbered clauses:
Clause 1: A method of enhancing an implementation of code changes, the method including accessing, via a continuous integration platform, a plurality of project-specific files hosted on a repository server, wherein the repository server is configured as a monolithic repository configured to host the plurality of project-specific files, determining, via the continuous integration platform, that a subset of the plurality of project-specific files has changed, generating, via the continuous integration platform, a specific task exclusively associated with the changed subset of the plurality of project-specific files, and transmitting, via the continuous integration platform, the specific task to a software development server configured to execute the specific task, wherein execution of the specific task exclusively effects the changed subset of the plurality of project-specific files.
Clause 2: The method according to clause 1, further including generating, via the continuous integration platform, a plurality of pipelines, wherein each pipeline of the plurality of pipelines includes a plurality of specific tasks exclusively associated with the changed subset of the plurality of project-specific files.
Clause 3: The method according to either of clauses 1 or 2, wherein the plurality of pipelines includes at least one of a build pipeline, a test pipeline, and a security scan pipeline, or combinations thereof.
Clause 4: The method according to any of clauses 1-3, further including causing, via the continuous integration platform, a display communicably coupled to the continuous integration platform to present a user interface including a plurality of widgets, wherein each widget of the plurality of widgets corresponds to each pipeline of the plurality of pipelines.
Clause 5: The method according to any of clauses 1-4, wherein each widget of the plurality of widgets includes a status button configured to provide an indication associated with a prior execution of at least one specific task of the plurality of specific tasks.
Clause 6: The method according to any of clauses 1-5, wherein the status button includes at least one of a success indicator, a failure indicator, a pending indicator, or an alert indicator, or combinations thereof.
Clause 7: The method according to any of clauses 1-6, further including displaying, via the continuous integration platform, information associated with the prior execution of the at least one specific task of the plurality of specific tasks in response to a user interaction with the alert indicator.
Clause 8: A system configured to enhance an implementation of code changes, the system including a software development server, a repository server configured to host a plurality of project-specific files, and a continuous integration server including a processor and a memory configured to store a continuous integration platform that, when executed by the processor, causes the continuous integration server to access the plurality of project-specific files hosted on the repository server, determine that a subset of the plurality of project-specific files has changed, generate a specific task exclusively associated with the changed subset of the plurality of project-specific files, and transmit the specific task to the software development server, wherein the software developer server is configured to execute the specific task, and wherein execution of the specific task exclusively effects the changed subset of the plurality of project-specific files.
Clause 9: The system according to clause 8, wherein the repository server is configured as a monolithic repository configured to host the plurality of project-specific files.
Clause 10: The system according to either of clauses 8 or 9, wherein the continuous integration server is further configured to generate a plurality of pipelines, wherein each pipeline of the plurality of pipelines comprises a plurality of specific tasks exclusively associated with the changed subset of the plurality of project-specific files.
Clause 11: The system according to any of clauses 8-10, wherein the plurality of pipelines comprises at least one of a build pipeline, a test pipeline, and a security scan pipeline, or combinations thereof.
Clause 12: The system according to any of clauses 8-11, wherein the continuous integration server is further configured to cause a display communicably coupled to the continuous integration server to present a user interface comprising a plurality of widgets, wherein each widget of the plurality of widgets corresponds to each pipeline of the plurality of pipelines.
Clause 13: The system according to any of clauses 8-12, wherein each widget of the plurality of widgets comprises a status button configured to provide an indication associated with a prior execution of at least one specific task of the plurality of specific tasks.
Clause 14: The system according to any of clauses 8-13, wherein the status button comprises at least one of a success indicator, a failure indicator, a pending indicator, or an alert indicator, or combinations thereof.
Clause 15: The system according to any of clauses 8-14, wherein the continuous integration server is further configured to display information associated with the prior execution of the at least one specific task of the plurality of specific tasks in response to a user interaction with the alert indicator.
Clause 16: A continuous integration server configured to enhance an implementation of code changes, the continuous integration server including a processor, and a memory configured to store a continuous integration platform that, when executed by the processor, causes the continuous integration server to access a plurality of project-specific files hosted on a repository server, determine that a subset of the plurality of project-specific files has changed, generate a specific task exclusively associated with the changed subset of the plurality of project-specific files, and transmit the specific task to a software development server configured to execute the specific task, wherein execution of the specific task exclusively effects the changed subset of the plurality of project-specific files.
Clause 17: The continuous integration server according to clause 16, wherein the repository server is configured as a monolithic repository configured to host the plurality of project-specific files.
Clause 18: The continuous integration server according to either of clauses 16 or 17, wherein the continuous integration server is further configured to generate a plurality of pipelines, wherein each pipeline of the plurality of pipelines comprises a plurality of specific tasks exclusively associated with the changed subset of the plurality of project-specific files.
Clause 19: The continuous integration server according to any of clauses 16-18, wherein the continuous integration server is further configured to cause a display communicably coupled to the continuous integration server to present a user interface comprising a plurality of widgets, wherein each widget of the plurality of widgets corresponds to each pipeline of the plurality of pipelines.
Clause 20: The continuous integration server according to any of clauses 16-19, wherein the continuous integration server is further configured to display information associated with a prior execution of at least one specific task of a plurality of specific tasks in response to a user interaction with an alert indicator.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference, and the disclosure expressly set forth in the present application controls.

Various exemplary, and illustrative aspects have been described. The aspects described herein are understood as providing illustrative features of varying detail of various aspects of the present disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the present disclosure. Accordingly, it will be recognized by persons having ordinary skill in the art that various substitutions, modifications, or combinations of any of the exemplary aspects may be made without departing from the scope of the claimed subject matter. In addition, persons skilled in the art will recognize, or be able to ascertain using no more than routine experimentation, many equivalents to the various aspects of the present disclosure upon review of this specification. Thus, the present disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one”, and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one”, and indefinite articles such as “a” or “an” (e.g., “a”, and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A, and B together, A, and C together, B, and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A, and B together, A, and C together, B, and C together, and/or A, B, and C together, etc.). It will be further understood by those within the art that typically a disjunctive word, and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A, and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,”, and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example, and without limitation, top, bottom, left, right, lower, upper, front, back, and variations thereof, shall relate to the orientation of the elements shown in the accompanying drawing, and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced, and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits, and by applying ordinary rounding techniques.

Any numerical range recited herein includes all sub-ranges subsumed within the recited range. For example, a range of “1 to 100” includes all sub-ranges between (and including) the recited minimum value of 1, and the recited maximum value of 100, that is, having a minimum value equal to or greater than 1, and a maximum value equal to or less than 100. Also, all ranges recited herein are inclusive of the end points of the recited ranges. For example, a range of “1 to 100” includes the end points 1, and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification, and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material, and the existing disclosure material.

The terms “comprise” (and any form of comprise, such as “comprises”, and “comprising”), “have” (and any form of have, such as “has”, and “having”), “include” (and any form of include, such as “includes”, and “including”), and “contain” (and any form of contain, such as “contains”, and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

The foregoing detailed description has set forth various forms of the devices, and/or processes via the use of block diagrams, flowcharts, and/or examples. Insofar as such block diagrams, flowcharts, and/or examples contain one or more functions, and/or operations, it will be understood by those within the art that each function, and/or operation within such block diagrams, flowcharts, and/or examples can be implemented, individually, and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry, and/or writing the code for the software, and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes, and/or devices described herein, or a microprocessor configured by a computer program which at least partially carries out processes, and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer readable storage medium. Firmware may be embodied as code, instructions or instruction sets, and/or data that are hard-coded (e.g., nonvolatile) in memory devices.

As used in any aspect herein, the terms “component,” “system,” “module”, and the like can refer to a computer-related entity, either hardware, a combination of hardware, and software, software, or software in execution.

As used in any aspect herein, an “algorithm” refers to a self-consistent sequence of steps leading to a desired result, where a “step” refers to a manipulation of physical quantities, and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These, and similar terms may be associated with the appropriate physical quantities, and are merely convenient labels applied to these quantities, and/or states.

1. A method of enhancing an implementation of code changes, the method comprising:
accessing, via a continuous integration platform, a plurality of project-specific files hosted on a repository server, wherein the repository server is configured as a monolithic repository configured to host the plurality of project-specific files;
determining, via the continuous integration platform, that a subset of the plurality of project-specific files has changed;
generating, via the continuous integration platform, a specific task exclusively associated with the changed subset of the plurality of project-specific files; and
transmitting, via the continuous integration platform, the specific task to a software development server configured to execute the specific task, wherein execution of the specific task exclusively effects the changed subset of the plurality of project-specific files.

2. The method of claim 1, further comprising generating, via the continuous integration platform, a plurality of pipelines, wherein each pipeline of the plurality of pipelines comprises a plurality of specific tasks exclusively associated with the changed subset of the plurality of project-specific files.

3. The method of claim 2, wherein the plurality of pipelines comprises at least one of a build pipeline, a test pipeline, and a security scan pipeline, or combinations thereof.

4. The method of claim 3, further comprising causing, via the continuous integration platform, a display communicably coupled to the continuous integration platform to present a user interface comprising a plurality of widgets, wherein each widget of the plurality of widgets corresponds to each pipeline of the plurality of pipelines.

5. The method of claim 4, wherein each widget of the plurality of widgets comprises a status button configured to provide an indication associated with a prior execution of at least one specific task of the plurality of specific tasks.

6. The method of claim 5 wherein the status button comprises at least one of a success indicator, a failure indicator, a pending indicator, or an alert indicator, or combinations thereof.

7. The method of claim 6, further comprising displaying, via the continuous integration platform, information associated with the prior execution of the at least one specific task of the plurality of specific tasks in response to a user interaction with the alert indicator.

8. A system configured to enhance an implementation of code changes, the system comprising:
a software development server;
a repository server configured to host a plurality of project-specific files; and
a continuous integration server comprising a processor and a memory configured to store a continuous integration platform that, when executed by the processor, causes the continuous integration server to:
access the plurality of project-specific files hosted on the repository server;
determine that a subset of the plurality of project-specific files has changed;
generate a specific task exclusively associated with the changed subset of the plurality of project-specific files; and
transmit the specific task to the software development server, wherein the software developer server is configured to execute the specific task, and wherein execution of the specific task exclusively effects the changed subset of the plurality of project-specific files.

9. The system of claim 8, wherein the repository server is configured as a monolithic repository configured to host the plurality of project-specific files.

10. The system of claim 8, wherein the continuous integration server is further configured to generate a plurality of pipelines, wherein each pipeline of the plurality of pipelines comprises a plurality of specific tasks exclusively associated with the changed subset of the plurality of project-specific files.

11. The system of claim 10, wherein the plurality of pipelines comprises at least one of a build pipeline, a test pipeline, and a security scan pipeline, or combinations thereof.

12. The system of claim 11, wherein the continuous integration server is further configured to cause a display communicably coupled to the continuous integration server to present a user interface comprising a plurality of widgets, wherein each widget of the plurality of widgets corresponds to each pipeline of the plurality of pipelines.

13. The system of claim 12, wherein each widget of the plurality of widgets comprises a status button configured to provide an indication associated with a prior execution of at least one specific task of the plurality of specific tasks.

14. The system of claim 13 wherein the status button comprises at least one of a success indicator, a failure indicator, a pending indicator, or an alert indicator, or combinations thereof.

15. The system of claim 14, wherein the continuous integration server is further configured to display information associated with the prior execution of the at least one specific task of the plurality of specific tasks in response to a user interaction with the alert indicator.

16. A continuous integration server configured to enhance an implementation of code changes, the continuous integration server comprising:
a processor; and
a memory configured to store a continuous integration platform that, when executed by the processor, causes the continuous integration server to:
access a plurality of project-specific files hosted on a repository server;
determine that a subset of the plurality of project-specific files has changed;
generate a specific task exclusively associated with the changed subset of the plurality of project-specific files; and
transmit the specific task to a software development server configured to execute the specific task, wherein execution of the specific task exclusively effects the changed subset of the plurality of project-specific files.

17. The continuous integration server of claim 16, wherein the repository server is configured as a monolithic repository configured to host the plurality of project-specific files.

18. The continuous integration server of claim 16, wherein the continuous integration server is further configured to generate a plurality of pipelines, wherein each pipeline of the plurality of pipelines comprises a plurality of specific tasks exclusively associated with the changed subset of the plurality of project-specific files.

19. The continuous integration server of claim 18, wherein the continuous integration server is further configured to cause a display communicably coupled to the continuous integration server to present a user interface comprising a plurality of widgets, wherein each widget of the plurality of widgets corresponds to each pipeline of the plurality of pipelines.

20. The continuous integration server of claim 16, wherein the continuous integration server is further configured to display information associated with a prior execution of at least one specific task of a plurality of specific tasks in response to a user interaction with an alert indicator.
